(19) United States
(12) Patent Application Publication
(10) Pub. No.: US 2025/0049131 A1
(43) Pub. Date: Feb. 13, 2025

(54) AEROSOL PROVISION DEVICE

(71) Applicant: NICOVENTURES TRADING LIMITED, London (GB)

(72) Inventor: Benjamin TAYLOR, London (GB)

(21) Appl. No.: 18/721,296

(22) PCT Filed: Dec. 19, 2022
(86) PCT No.: PCT/EP2022/086781

§ 371 Date: Jun. 18, 2024

(30) Foreign Application Priority Data
Dec. 20, 2021 (GB) 2118514.5

(51) Int. Cl. A24F 40/465; A24F 40/20

(52) U.S. Cl. CPC A24F 40/465; A24F 40/20

(57) ABSTRACT

An aerosol provision device for generating an aerosol from aerosol-generating material. The device has a heating assembly including a heating zone for receiving at least a portion of an article including aerosol-generating material; and a magnetic field generator configured to generate a varying magnetic field having a coil at least partially encircling the heating zone. The coil is separable along a juncture.

### RELATED APPLICATIONS

The present application is a National Phase entry of PCT Application No. PCT/EP2022/086781 filed Dec. 19, 2022, which claims priority to GB Application No. 2118514.5 filed Dec. 20, 2021, each of which is hereby incorporated by reference in their entirety.

### TECHNICAL FIELD

The present invention relates to aerosol provision device for generating an aerosol from aerosol-generating material. The present invention also relates to a system comprising an aerosol provision device and an article comprising aerosol-generating material.

### BACKGROUND

Methods of, and devices for, extraction of compounds from materials have long been used to provide users with the pleasurable or medicinal benefits of the inhalation of such compounds. Attempts have been made to provide products that release compounds without burning. Examples of such products are heating devices which release compounds by heating, but not burning, the material. The material may, for example, contain nicotine.

### SUMMARY

In accordance with some embodiments described herein, there is provided an aerosol provision device for generating an aerosol from aerosol-generating material, comprising: a heating assembly comprising: a heating zone for receiving at least a portion of an article comprising aerosol-generating material; a magnetic field generator configured to generate a varying magnetic field comprising a coil at least partially encircling the heating zone; wherein the coil is separable along a juncture.

The coil may define a longitudinal axis. The coil may be separable in a direction perpendicular to the longitudinal axis. The coil may be separable in a direction along the longitudinal axis.

The coil may be arranged to be separable into a first coil portion and a second coil portion.

The first portion may be movable relative to the second portion to provide access to the heating zone.

The first coil portion and the second coil portion may be electrically connected in an operating condition.

The first coil portion and the second coil portion may form a unified coil when in the operating condition.

The first and second coil portions may be electrically disconnected in a non-operating condition.

When the housing is in a closed configuration, the second coil portion may interact with the first coil portion to form a closed coil configuration encircling the heating zone.

The coil may be separable into the first and second coil portions to provide access to the heating zone in the non-operating condition.

The juncture may extend in a longitudinal direction of the coil.

The aerosol provision device may comprise a housing, the housing being separable into a first housing portion and a second housing portion.

The first housing portion and second housing portion may be movable relative to one another to provide access to the heating zone.

The housing may form a clamshell opening to the heating zone.

The first coil portion may be in the first housing portion and the second coil portion may be in the second housing portion.

The first housing portion may be movable with respect to the second housing portion by a hinge mechanism.

The first housing portion may be arranged to pivot with respect to the second housing portion about a line parallel to the longitudinal axis of the device.

The first housing portion may be arranged to pivot with respect to the second housing portion about a line perpendicular to the longitudinal axis of the device.

The first housing portion may be movable with respect to the second housing portion by a sliding mechanism.

The sliding mechanism may be arranged to allow the first housing portion to slide with respect to the second housing portion in a direction parallel to the longitudinal axis. The sliding mechanism may be arranged to allow the first housing portion to slide with respect to the second housing portion in a direction perpendicular to the longitudinal axis.

At least one of the first and second housing portions may be a cover.

The first coil portion may be connected to a power supply.

The second coil portion may be indirectly electrically connected to the first coil by the first coil portion.

Terminals of the coil may be both located in one of the first or second coil portions.

An electrical connection may be provided between the first and second coil portions.

The electrical connection may be at the juncture

The electrical connection may connect when first and second coil portions are in a closed condition, and may be non-connected in an open condition.

The second coil portion may be a passive coil portion

The coil may comprise a plurality of turns, wherein each turn is separable into two sections.

An electrical contact may be defined at each turn juncture.

Opposing electrical contacts may be brought into abutment upon moving into a closed condition.

The electrical contact may comprise a region of increased coil diameter.

Each coil portion may be held in place by a carrier.

Each coil portion may be embedded in a carrier (injection molding) with only the turn junctures not embedded.

The electrical contact may comprise a pogo pin.

The first coil portion may be a separate component to the second coil portion.

The first coil portion may be integral with the second coil portion.

The first and second coil portions may be symmetrical about the axis of the coil. The first and second coil portions may be asymmetrical about the axis of the coil.

The heating assembly may comprise a heating element.

The heating element may define the heating zone.

The heating element may be tubular.

The heating element may be separable into a first heating portion and a second heating portion.

The heating element may be separable into the first and second coil portions to provide access to the heating zone in the non-operating condition.

The coil may be helical.

The first coil portion may be at least one of pivotable, slidable and detachable relative to the second coil portion.

The heating element may be configured to generate heat in the presence of a varying magnetic field.

The first heating portion may be movable with the first coil portion. The second heating portion may be movable with the second coil portion.

The heating element may extend in the heating zone. The heating element may protrude in the heating zone. The heating element may protrude from the base end of the heating zone.

In accordance with some embodiments described herein, there is provided an aerosol generating device for generating an aerosol from aerosol-generating material, comprising: a heating assembly comprising: a heating zone for receiving at least a portion of an article comprising aerosol-generating material; a magnetic field generator configured to generate a varying magnetic field comprising a helical coil at least partially encircling the heating zone; wherein the helical coil comprises a first portion and a second portion, wherein the first portion is movable relative to the second portion to provide access to the heating zone.

In accordance with some embodiments described herein, there is provided an aerosol generating device for generating an aerosol from aerosol-generating material, comprising: a heating assembly comprising: a heating zone for receiving at least a portion of an article comprising aerosol-generating material; and a magnetic field generator configured to generate a varying magnetic field comprising a coil at least partially encircling the heating zone; and a heating element, wherein the heating element is separable along a juncture.

In accordance with some embodiments described herein, there is provided an aerosol generating device for generating an aerosol from aerosol-generating material, comprising: a heating assembly comprising: a heating element defining a heating zone for receiving at least a portion of an article comprising aerosol-generating material; and wherein the heating element is separable along a juncture.

In accordance with some embodiments described herein, there is provided an aerosol provision device system comprising the aerosol provision device of any described above, and an article containing aerosol generating material, in which the article is at least partially receivable in the heating zone of the aerosol provision device.

The article may comprise a heating element. The heating element may be in the aerosol generating material.

The apparatus of these aspects can include one or more, or all, of the features described above, as appropriate.

### BRIEF DESCRIPTION OF THE DRAWINGS

Embodiments will now be described, by way of example only, and with reference to the accompanying drawings in which:

FIG. 1 shows a front perspective view of an aerosol provision system with an aerosol provision device and an article inserted into the device;

FIG. 2 shows schematically the aerosol provision device of FIG. 1;

FIG. 3 shows schematically the device of FIG. 2, where the receptacle comprises a heating element;

FIG. 4 shows schematically the device of FIG. 2, where a heating element protrudes in the heating zone;

FIG. 5 shows schematically the device of FIG. 2 showing the coil in detail and an article inserted in the heating zone;

FIG. 6 shows schematically the device as illustrated in FIG. 5 with the article removed;

FIG. 7 shows schematically a split coil for use in the device;

FIG. 8 shows schematically a device including the split coil of FIG. 7 with a hinged arrangement;

FIG. 9 shows schematically a device including the split coil of FIG. 7 with a sliding arrangement;

FIG. 10 shows schematically a device including the split coil of FIG. 7, with a laterally extending housing portion;

FIG. 11 shows schematically a split coil for use in the device;

FIG. 12 shows schematically a device with the split coil as shown in FIG. 11;

FIG. 13 shows schematically a device with a side opening door and the split coil;

FIG. 14a shows schematically a plan view of a turn of a coil for use in the device of FIG. 13;

FIG. 14b shows schematically a plan view of a turn of another coil for use in the device of FIG. 13;

FIG. 15 shows schematically a coil for use in the device of FIG. 13; and

FIG. 16 shows schematically a device as shown in FIG. 13 with a pivoting tubular heating element.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavorants. Aerosol generating material may include any plant based material, such as any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt % or 70 wt % of amorphous solid, to about 90 wt %, 95 wt % or 100 wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

An aerosol generating device can receive an article comprising aerosol generating material for heating. An “article” in this context is a component that includes or contains in use the aerosol generating material, which is heated to volatilize the aerosol generating material, and optionally other components in use. A user may insert the article into the aerosol generating device before it is heated to produce an aerosol, which the user subsequently inhales. The article may be, for example, of a predetermined or specific size that is configured to be placed within a heating chamber of the device which is sized to receive the article.

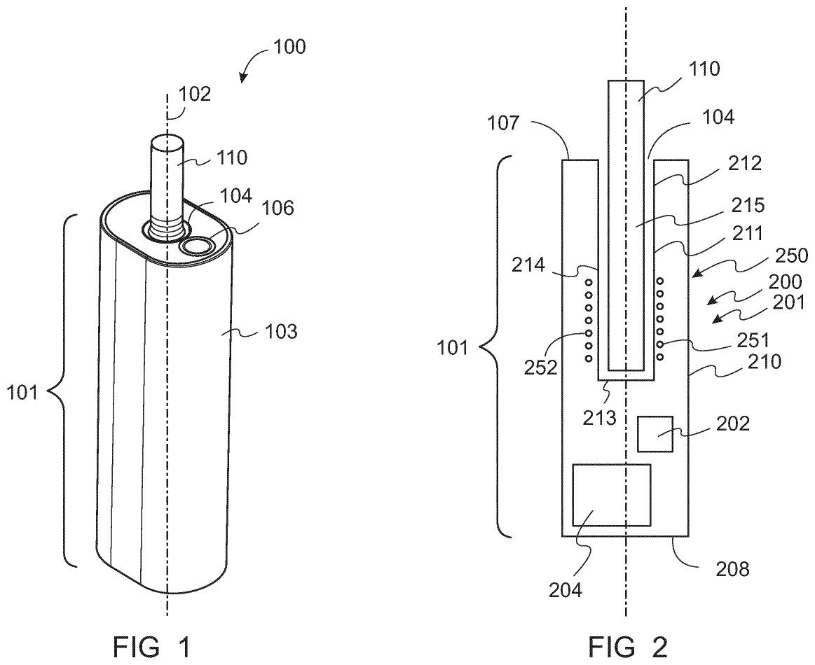

FIG. 1 shows an example of an aerosol provision system 100. The system 100 comprises an aerosol provision device 101 for generating aerosol from an aerosol generating material, and a replaceable article 110 comprising the aerosol generating material. The device 101 can be used to heat the replaceable article 110 comprising the aerosol generating material, to generate an aerosol or other inhalable material which can be inhaled by a user of the device 101.

The device 101 comprises a housing 103 which surrounds and houses various components of the device 101. The housing 103 is elongate. The device 101 has an opening 104 in one end, through which the article 110 can be inserted for heating by the device 101. The article 110 may be fully or partially inserted into the device 101 for heating by the device 101.

The device 101 may comprise a user-operable control element 106, such as a button or switch, which operates the device 101 when operated, e.g. pressed. For example, a user may activate the device 101 by pressing the switch 106.

FIG. 2 is a schematic illustration of the aerosol provision system 100 of FIG. 1, showing various components of the device 101. It will be appreciated that the device 101 may include other components not shown in FIG. 2 and that some components shown in FIG. 2 may not be present in some embodiments.

As shown in FIG. 2, the device 101 includes an aerosol generator 200. The aerosol generator 200 includes a heating assembly 201, a controller (control circuit) 202, and a power source 204. The aerosol generator 200 comprises a body assembly 210. The body assembly 210 may include a chassis and other components forming part of the device. The heating assembly 201 is configured to heat the aerosol-generating material of an article 110 inserted into the device 101, such that an aerosol is generated from the aerosol generating material. The power source 204 supplies electrical power to the heating assembly 201, and the heating assembly 201 converts the supplied electrical energy into heat energy for heating the aerosol-generating material.

The aerosol generator 200 defines a longitudinal axis 102, along which an article 110 may extend when inserted into the device 101. The opening 104 is aligned on the longitudinal axis 102.

The power source 204 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery.

The power source 204 may be electrically coupled to the heating assembly 201 to supply electrical power when required and under control of the controller 202 to heat the aerosol generating material. The control circuit 202 may be configured to activate and deactivate the heating assembly 201 based on a user operating the control element 106. For example, the controller 202 may activate the heating assembly 201 in response to a user operating the switch 106.

The end of the device 101 closest to the opening 104 may be known as the proximal end (or mouth end) 107 of the device 101 because, in use, it is closest to the mouth of the user. In use, a user inserts an article 110 into the opening 104, operates the user control 106 to begin heating the aerosol generating material and draws on the aerosol generated in the device. This causes the aerosol to flow through the article 110 along a flow path towards the proximal end of the device 101.

The other end of the device furthest away from the opening 104 may be known as the distal end 108 of the device 101 because, in use, it is the end furthest away from the mouth of the user. As a user draws on the aerosol generated in the device, the aerosol flows in a direction towards the proximal end of the device 101. The terms proximal and distal as applied to features of the device 101 will be described by reference to the relative positioning of such features with respect to each other in a proximal-distal direction along the axis 102.

The heating assembly 201 may comprise various components to heat the aerosol generating material of the article 110 via an inductive heating process or a resistive heating process, for example. Induction heating is a process of heating an electrically conducting heating element (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive element and the susceptor, allowing for enhanced freedom in construction and application. Resistive heating instead utilizes the Joule heating effect arising from the electrical resistance of a material in response to application of a current directly therethrough.

The aerosol generator 200 includes a heating chamber 211 configured and dimensioned to receive the article 110 to be heated. The heating chamber 211 defines a heating zone 215. In the present example, the article 110 is generally cylindrical, and the heating chamber 211 is correspondingly generally cylindrical in shape. However, other shapes would be possible. The heating chamber 211 is formed by a receptacle 212. The receptacle 212 includes an end wall 213 and a peripheral wall 214. The end wall 213 acts as a base of the receptacle 212. The receptacle 212 in embodiments is a one-piece component. As used herein, the term ‘one-piece component’ is intended to mean that the features are formed together such that no joints are defined therebetween. In other embodiments the receptacle 212 comprises two or more components.

The heating chamber 211 is defined by the inner surfaces of the receptacle 212. The receptacle 212 acts as a support member. The receptacle 212 comprises a generally tubular member. The receptacle 212 extends along and around and substantially coaxial with the longitudinal axis 102 of the device 101. However, other shapes would be possible. The receptacle 212 (and so heating zone 215) is open at its proximal end such that an article 110 inserted into the opening 104 of the device 101 can be received by the heating chamber 211 therethrough. The receptacle 212 is closed at its distal end by the end wall 213. The receptacle 212 may comprise one or more conduits that form part of an air path. In use, the distal end of the article 110 may be positioned in proximity or engagement with the end of the heating chamber 211. Air may pass through the one or more conduits forming part of the air path, into the heating chamber 211, and flow through the article 110 towards the proximal end of the device 101.

The receptacle 212 may be formed from an insulating material. For example, the receptacle 212 may be formed from a plastic, such as polyether ether ketone (PEEK). Other suitable materials are possible. The receptacle 212 may be formed from such materials ensure that the assembly remains rigid/solid when the heating assembly 201 is operated. Using a non-metallic material for the receptacle 212 may assist with restricting heating of other components of the device 101. The receptacle 212 may be formed from a rigid material to aid support of other components.

Other arrangements for the receptacle 212 would be possible. For example, in an embodiment the end wall 213 is defined by part of the heating assembly 201. In embodiments, the receptacle 212 comprises material that is heatable by penetration with a varying magnetic field. In some embodiments, the receptacle 212 comprises a material heatable by resistive Joule heating. Such a receptacle acts as a heating element.

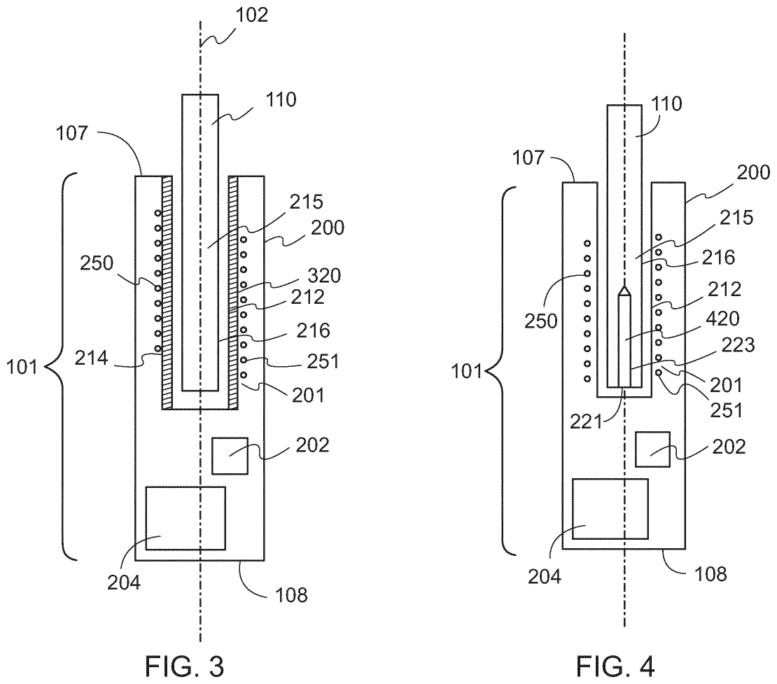

As illustrated in FIG. 3, the heating assembly 201 may comprise a heating element 320 positioned surrounding the heating zone 215. In such an arrangement, the heating element 320 forms the receptacle 212. The heating element 320 defines the peripheral wall 214. The heating element 320 is configured to heat the heating zone 215. The heating zone 215 is defined in the heating chamber 211. In embodiments the heating chamber 211 defines a portion of the heating zone 215 or the extent of the heating zone 215.

The heating element 320 is heatable to heat the heating zone 215. The heating element 320 may be an induction heating element or a resistive heating element. That is, the heating element 320 is heatable by penetration with a varying magnetic field or a resistive material heatable by passing a current directly therethrough from a power source. The heating element 320 comprises electrically conducting material suitable for heating by electromagnetic induction. For example, the heating element 320 may be formed from a carbon steel. It will be understood that other suitable materials may be used, for example a ferromagnetic material such as iron, nickel or cobalt.

As shown in FIG. 2, the heating assembly 201 comprises a magnetic field generator 250. The magnetic field generator 250 is configured to generate one or more varying magnetic fields that penetrate the heating element 320 so as to cause heating in the heating element 320. The magnetic field generator 250 includes an inductor coil arrangement 251. The inductor coil arrangement comprises an inductor coil 252, acting as an inductor element. The inductor coil 252 may be a helical coil, however other arrangements are envisaged. In embodiments, the inductor coil arrangement 251 comprises two or more inductor coils. The two or more inductor coils in embodiments are disposed adjacent to each other and may be aligned co-axially along the axis.

In some examples, in use, the magnetic field generator 250 is configured to heat the heating element 320 to a temperature of between about 200° C. and about 350° C., such as between about 240° C. and about 300° C., or between about 250° C. and about 280° C. In examples where the heating element is a resistive heating element, similar or the same temperatures may be reached by resistive heating therein.

The inductor coil 252 may be a helical coil comprising electrically-conductive material, such as copper. The coil is formed from wire, such as Litz wire, which is wound helically around a support member (not shown). The support member is formed by the receptacle 212 or by another component. In embodiments, the support member is omitted. The support member is tubular. The coil 252 defines a generally tubular shape. The inductor coil has a generally circular profile. In other embodiments, the inductor coil may have a different shape, such as generally square, rectangular or elliptical. The coil width may increase or decrease along its length.

With a helical coil it is possible to define an elongate inductor zone in which to receive a susceptor, which provides an elongate length of susceptor to be received in the elongate inductor zone. The length of susceptor subjected to varying magnetic field may be maximised. By providing an enclosed inductor zone with a helical coil arrangement it is possible to aid the flux concentration of the magnetic field.

The configuration of the helical inductor coil may vary along its axial length. For example, the inductor coil, or each inductor coil, may have substantially the same or different values of inductance, axial lengths, radii, pitches, numbers of turns, etc. In embodiments, such as that shown in FIGS. 4, the heating element 420 extends in the heating zone 215. The heating element 420, acting as a protruding element, protrudes in the heating zone 215. The heating element 420 upstands from the base. The heating element 420 is spaced from the peripheral wall 214. The heating assembly 201 is configured such that when an article 110 is received by the heating chamber 211, the heating element 420 extends into a distal end of the article 110. The heating element 420 is positioned, in use, within the article 110. The heating element 420 is configured to heat aerosol generating material of an article 110 from within, and for this reason is referred to as an inner heating element.

The heating element 420 extends into the heating chamber 211 from the distal end of the heating chamber 211 along the longitudinal axis 102 of the device (in the axial direction). In embodiments the heating element 420 extends into the heating chamber 211 spaced from the axis 102. The heating element 420 may be off-axis or non-parallel to the axis 102. Although one heating element 420 is shown, it will be understood that in embodiments, the heating assembly 201 comprises a plurality of heating elements 420. Such heating elements in embodiments are spaced from but parallel to each other.

When the heating element 320, 420 of any of the described embodiments utilizes heating via magnetic susceptibility, the inductor coil 252 may be disposed external to the receptacle 212. The inductor coil may encircle the heating zone 215. The helical inductor coil may extend around at least a portion of the heating element 320, 420, acting as a susceptor. The helical inductor coil is configured to generate a varying magnetic field that penetrates the heating element 320, 420. The helical inductor coil is arranged coaxially with the heating chamber 211 and longitudinal axis 102.

Although the illustrated embodiments show devices including either a heating element 320 disposed around the heating zone 215 and at least one heating element 420 disposed within the heating zone 215, any of the described embodiments may utilized both a heating element 320 surrounding the heating zone 215 and one or more heating elements 420 within the heating zone 215.

The device may comprise neither heating element 320 nor heating element 420 and instead comprises a coil 252 configured to generate resistive heat when a current is passed therethrough. In this embodiment, the receptacle may be made from a thermally conductive material so as to allow the heat generated by the coil 252 to be transferred to an article 110 inserted in the device.

In FIG. 4, the heating element 420 protrudes in the heating zone 215 and is received by the article 110. FIG. 2 shows the article 110 received in the device 101. The article 110 is sized to be received by the receptacle 212. The outer dimensions of the article 110 perpendicular to the longitudinal axis of the article 110 substantially correspond with the inner dimensions of the chamber 211 perpendicular to the longitudinal axis 102 of the device 101 to allow insertion of the article 110 into the receptacle 212. In embodiments, a gap 216 is defined between an outer side 111 of the article 110 and an inner side 217 of the receptacle 212. The gap 216 may act as an air passage along at least part of the axial length of the chamber 211. An insertion end 112 of the article 110 is arranged to lie adjacent to the base of the receptacle 212.

FIG. 2 illustrates a basic structure of the device 101. FIG. 2 generally shows an article 110 disposed within the heating zone 215 of a device 101. This is an in-use configuration in which the aerosol-generating material in the article may be heated and a user may draw the aerosolized material from the article/device.

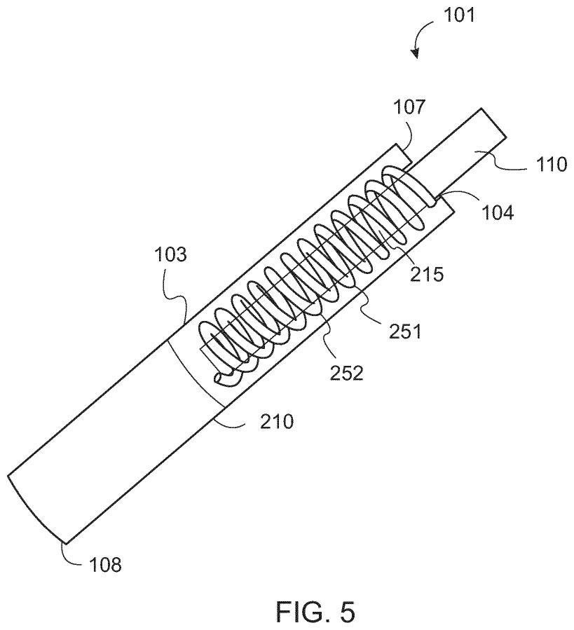

FIG. 5 shows another view of the device 101. In this figure, the coil 252 is shown in full, surrounding the receptacle 212 (not shown) and article 110 disposed in the receptacle 212. The heating element arrangement of the device 101 of FIG. 5 can be any of those previously described.

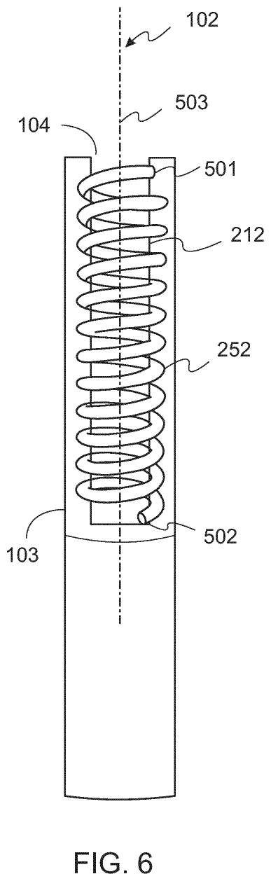

FIG. 6 shows a view of the device 101 without an article inserted therein. As can be seen, the coil 252 has an axis 503 which is substantially aligned with the longitudinal axis 102 of the device 101. Other embodiments wherein the longitudinal axis 102 of the device 101 and the axis 503 of the coil 252 are not aligned are also envisaged. The device 101 is provided with an opening 104 in the receptacle 212 and housing 103 at the proximal end 107 of the device 101. In order to insert an article 110 into the device 101 to be heated, the user typically slides and inserts the article 110 through the opening 104 into the heating zone 215 in a direction along the longitudinal axis 102, and in the case of the embodiment of FIG. 6, also along the axis 503 of the coil 252.

As described herein, modifications to the modes of insertion are considered, such as insertion of the article 110 into the receptacle 212 from a direction perpendicular to the longitudinal axis 102 of the device 101, or at least in a direction with a component perpendicular to the longitudinal axis 102 of the device 101. In order to achieve this, embodiments will now be described which generally involve the use of a split coil 352, i.e. a coil with re-connectable discontinuities along its length. In these embodiments, the receptacle 212 and housing 103 are also discontinuous around the circumference and length of the device and are in the form of multiple parts in order to provide access to the heating zone 215. These embodiments will now be described in more detail.

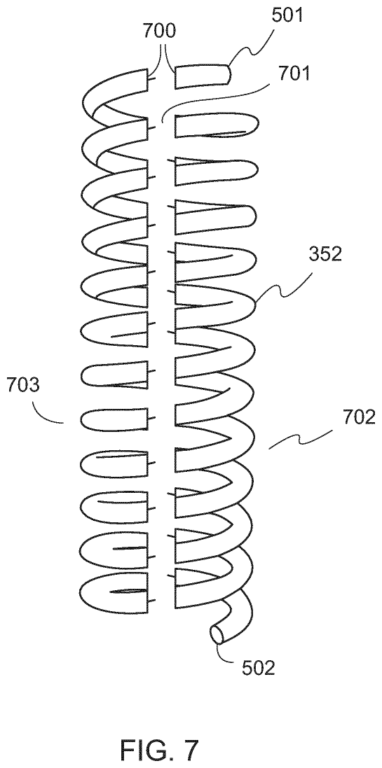

FIG. 7 shows the split coil 352 for use in the device 101. FIG. 7 shows the coil 252 of FIG. 6 in two portions. In this figure, the split coil 352 is shown to comprise two discontinuities 701 per turn of the coil 352, the discontinuities of each turn at 180 degrees from one another and the discontinuities of each turn aligned with one another. In other words, the coil 352 has been split evenly into two halves through a plane defined by the longitudinal axis and a particular circumferential angular position. The two halves may be referred to respectively as the first coil portion 702 and second coil portion 703.

The split coil 352 has two terminals 501 and 502. These terminals are both positioned on one portion, which in FIG. 7 is the first coil portion 702. The terminals are configured to be connected to the power source 204 and controller 202 of the device 101. This means that when the two portions of the split coil 352 are separated from one another, the second coil portion 703 is a passive coil portion and is not connected to any power supply. As also shown in FIG. 7, the split coil 352 may be provided with connection means 700, which are configured to facilitate the connection between corresponding turns of each coil portion. This connection means 700 enables the two coil portions to be connected to one another to form a complete coil without being perfectly aligned with one another. The connection means 700 further provides protection for the coil turns from dirt or residue which may otherwise compromise the ability to connect the portions to form a complete coil. The connection means 700 provides that a reliable electrical connection may be made between corresponding turns of each coil portion even in the presence of unwanted dirt, residue or debris. The connection means 700 may comprise pogo pins or any other suitable alternative. Any embodiments of a split coil 352 described herein may be provided with connection means 700.

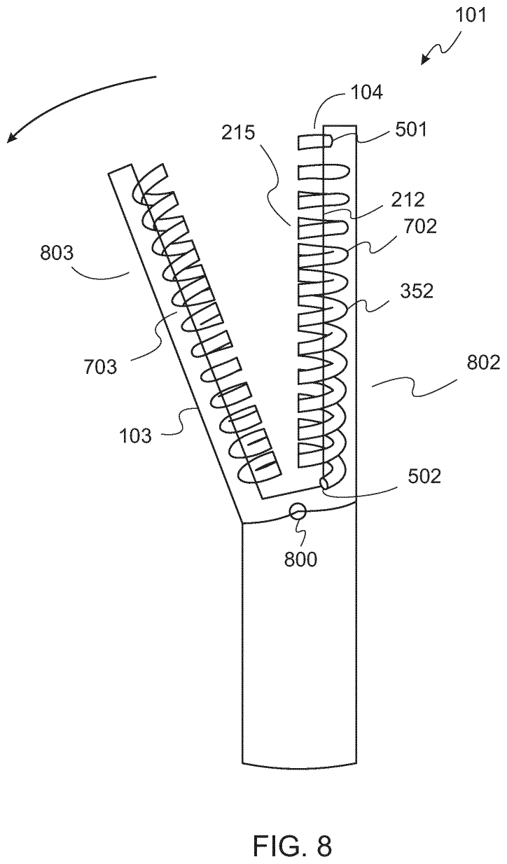

FIG. 8 shows an embodiment of the device 101 comprising the split coil 352. In this embodiment, as shown, the device housing 103 and receptacle 212 are also split into first and second device portions 802 and 803. Each device portion comprises one portion of the split coil 352, a portion of the receptacle 212 and a portion of the housing 103. In this embodiment, a hinge 800 is provided between the first and second device portions 802 and 803. In effect, this enables the heating zone 215 to be exposed laterally and therefore enables insertion of an article 110 from a lateral direction, i.e. not just through opening 104. This facilitates insertion of the article 110 and minimises risk of damage to the article 110.

Although the device 101 of FIG. 8 is shown to comprise an opening 104, such that the article 110 may also be inserted through opening 104 to result in the in-use configuration shown in FIG. 5, it is also contemplated that no such opening 104 is provided in the embodiment of the device 101 shown in FIG. 8 such that the article 110 can only be inserted laterally through the hinged opening of the first and second device portions 802 and 803. Of course, in such an embodiment, the article 110 would be of a shorter length than the one shown in FIG. 5, and be the same length or shorter than the receptacle 212. The article 110 may be at least partially encapsulated by the receptacle 212 and housing 103 when the device portions 802 and 803 are connected in a closed configuration. In this case, a mouthpiece may be provided at an opening in the top of the receptacle 212 at the proximal end 107 of the device 101 to enable the user to draw aerosolized material from the device 101 during operation. Regardless of the presence of an opening 104 or the mechanism of opening and closure of the device via first and second device portions 802 and 803, it should be appreciated that, once the device 101 is in a closed configuration such that the first and second device portions 802 and 803 are connected to one another, the split coil 352, the receptacle 212 and the device as a whole will operate in the same way as described above with reference to FIG. 5 or as described in any previous embodiment in relation to FIGS. 1 to 4.

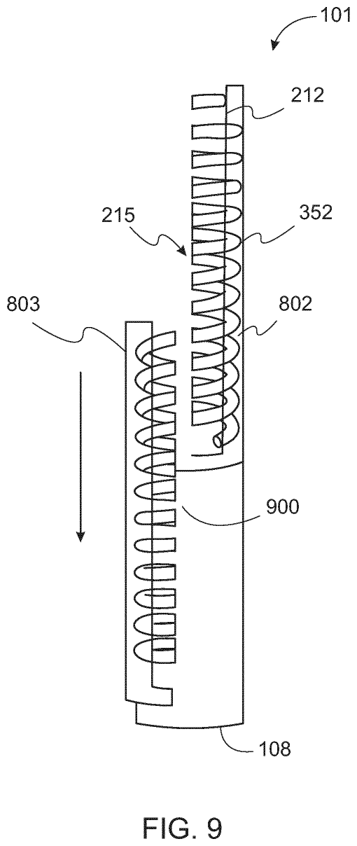

FIG. 9 shows another embodiment of the device 101. The device may comprise any combination of the features described in relation to FIG. 8. The difference between the embodiment of this figure and that of FIG. 9 is the mechanism by which the first and second device portions 802 and 803 separate from one another to expose the heating zone 215. As shown in the figure, rather than utilizing a hinge arrangement between the first and second device portions 802 and 803, a sliding arrangement 900 is provided. Whilst the first device portion 802 is unchanged with respect to that shown in FIG. 8, the second device portion 803 is mounted to the device by a sliding mechanism so as to allow the portion 803 to translate along the device 101 parallel to the longitudinal axis 102 of the device 101 towards the distal end 108, thereby exposing the heating zone 215.

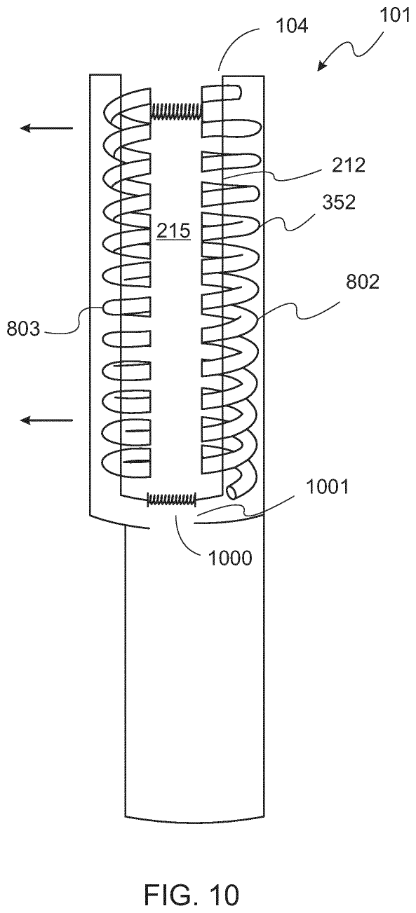

FIG. 10 shows a further embodiment of the device 101. Like the embodiment of FIG. 9, the device may comprise any combination of the features described in relation to FIG. 8. In this embodiment, however, rather than the hinge mechanism of FIG. 8, or the sliding arrangement 900 of FIG. 9, the device 101 of FIG. 10 is provided with a spring means 1000. The spring means 1000 may be configured to separate the device portions 802 and 803 from one another in a lateral direction, perpendicular to the longitudinal axis 102 of the device 101. The device portions 802 and 803 are configured to be able to be manually pressed together by a user to connect the device portions 802 and 803 together to connect the split coil 352 and form a laterally enclosed heating zone 215. The device may further be provided with a locking arrangement 1001, which locks the device portions 802 and 803 together.

The locking arrangement 1001 may be configured to be simply unlocked by the user during operation. In this way, the user may release a latch of the locking arrangement to release the second device portion 803 from the first device portion 802, thereby allowing the portions to be separated from one another by the bias in the spring means and allowing the heating zone 215 to be exposed. As with the previously described split coil embodiments, the device may or may not be provided with the opening 104 through which an article may be inserted into the receptacle 212. Even when an article 110 is inserted axially through the opening 104 in this case, the insertion of the article 110 is facilitated by the increase in diameter of the opening 104 and the receptacle 212, thereby also reducing the chance of damage to the article 110 upon insertion.

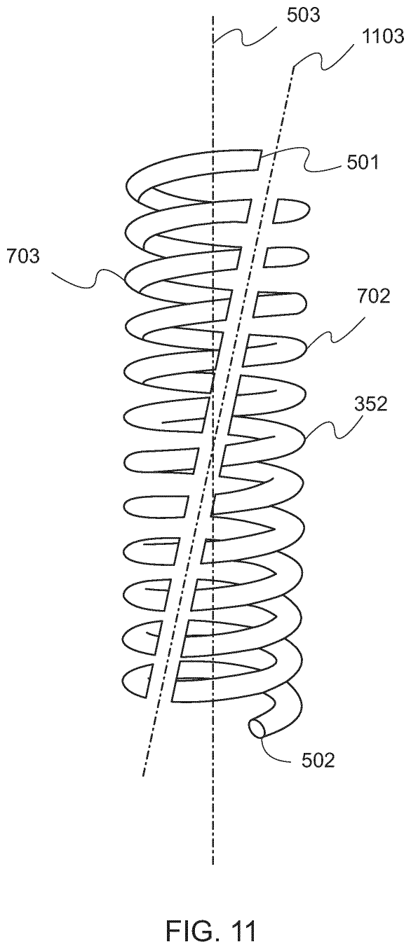

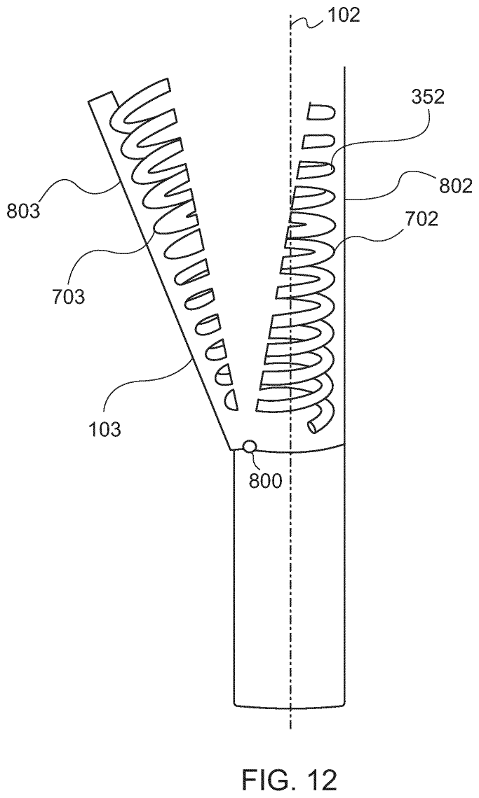

Although the previously described embodiments have generally described a coil 325 split into two even halves, the coil 352 may be split into first and second portions 702 and 703 along any plane, and may be split unevenly. FIG. 11 shows just one example of another configuration of a split coil 352 which may be used in any of the aforementioned split coil embodiments. As can be seen from the figure, the coil 352 is split along a plane 1103 which is non-parallel to the longitudinal axis 503 of the coil 352. FIG. 12 shows an example of the device 101 with a split coil 352 according to the embodiment shown in FIG. 11. The device 101 in FIG. 12 is provided with a hinge arrangement 800 similar to that of FIG. 8. As can be seen, the housing 103 and receptacle 212 of the device 101 are also split along a plane which is non-parallel to the longitudinal axis 102 of the device 101.

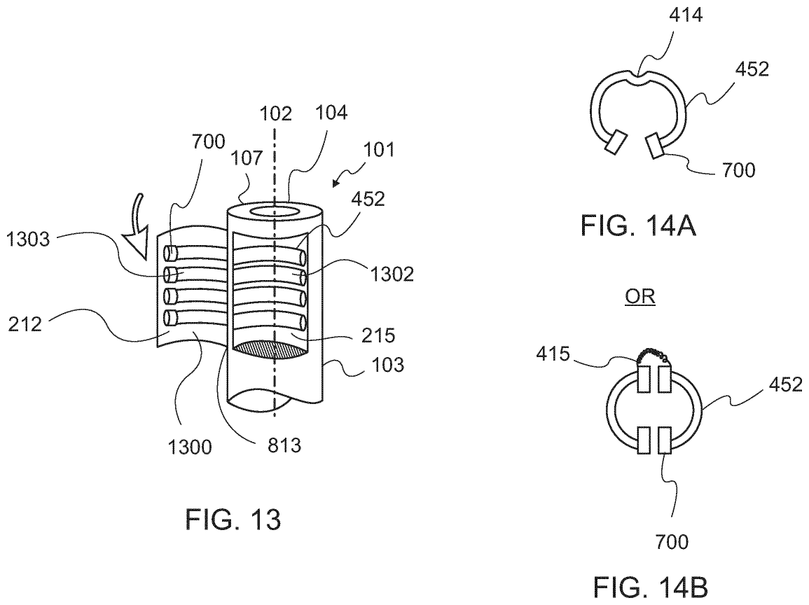

FIG. 13 shows a further embodiment of the device 101. This embodiment differs from those in FIGS. 7 to 12 in that the device 101 comprises a split coil 452 which may not be split into two distinct portions. As can be seen from the figure, the device 101 utilizes a different configuration to enable lateral access to the heating zone 215. A door 1300 is provided which comprises a segment of the housing 103, receptacle 212 and coil 452. In contrast with the second device portions 803 of the embodiments of FIGS. 8 to 10 and 12, the door 1300 is configured to swing open on a hinge 813 about a pivot parallel to the longitudinal axis 102 of the device 101.

It is contemplated that the door 1300 may include the upper proximal surface of the device 101 and a mouthpiece thereon, if provided. This would expose the heating zone 215 to the proximal end of the device 101 which may further facilitate insertion of an article 110. The hinge 813 may be provided only in the receptacle 212 and the housing 103. The coil 452 may, at the location of the hinge 813 rely on its intrinsic elastic nature to deform elastically as the section 1303 of the coil 452 affixed to the door 1300 pivots with respect to remaining section 1302 of the coil 452 in the device 101. The coil 452 may only comprise one discontinuity per turn, rather than two, as in the embodiments of FIGS. 7 to 12. A plan view of one turn of such a coil is shown in FIG. 14a.

The coil turn of FIG. 14a is shown in partially deformed state which represents the state it would experience when the door 1300 of the device 101 in FIG. 13 is partially opened. The turns of the coil may pivot around a point 414 at a corresponding circumferential location to that of the hinge 813 when positioned in the device. Providing just one discontinuity per turn as in the embodiment of the coil 452 of FIG. 14a reduces the risk of dirt or residue contaminating the contacts between corresponding turns of the two portions of the split coil 452.

As shown in FIG. 14a, the coil 452 may be provided with connection means 700 at each discontinuity in order to facilitate connection thereacross and also to reduce the risk of dirt or other contamination compromising the connection between the corresponding turns of each portion of the coil 452. In addition to the benefits relating to reliability of the connection between the two coil portions, providing a coil 452 which deforms elastically when the door 1300 is opened also provides a return bias for the closure of the door 1300. The elasticity of the coil provides a bias to close the door 1300, further facilitating usability and precluding the need for a separate mechanism to lock the door 1300 to the device 101 during operation.

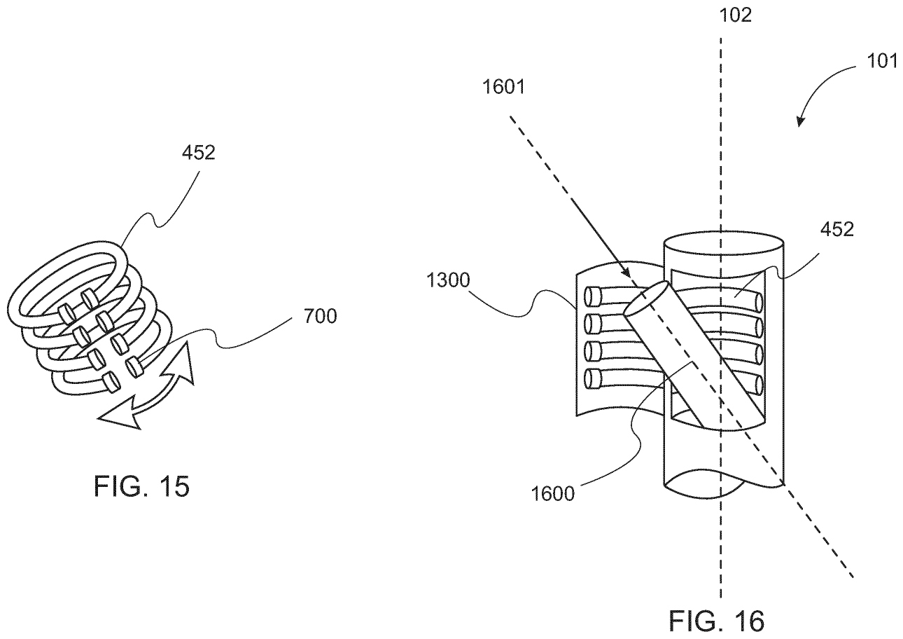

FIG. 15 shows another schematic view of a coil 452 according to FIG. 14a. FIG. 14b represents an alternative embodiment of the coil 452 for use in the device of FIG. 13. As seen in the figure, the turns of the coil each comprise two discontinuities, at 180 degrees from one another, similar to the coil 352 of the embodiments of FIGS. 7 to 12. The discontinuities are also provided with connection means 700. However, this coil 452 is further provided with a spring 415 between one of the discontinuities per turn. This spring 415 provides the same functionality as the elastic nature of the coil 452 of FIG. 14a around pivot point 414. The spring 415, due to its biasing together of the discontinuities between which it is attached, also aids in the connection of these corresponding coil turns of the two coil portions when the door 1300 closes and the device 101 is in operation.

It is also contemplated that the door 1300 may be attached to a sliding mechanism configured to allow the door 1300 to slide circumferentially around the outer surface of the housing 103 of the device 101 to expose the heating zone 215.

As previously discussed, the coil 252, 352, 452, of any embodiment disclosed herein may be part of an electrically inductive or resistive heating system. For induction heating systems, the coil is configured to generate a varying magnetic field through application of a varying electrical current therethrough. In addition to the coil, the heating element 320 is also required. The heating element 320 is configured to generate heat in response to a varying magnetic field being pass therethrough and therefore acts as a heating element. As shown in FIG. 3, the heating element 320 may take a tubular form and may form the receptacle 212 itself. Alternatively or additionally, the heating element 420 may take the form of a pin, as shown in FIG. 4. The embodiments of the device 101 described herein with a split coil may utilize either one of these heating elements. However, these heating element designs may not be very conducive to the side-loading of an article 110 into the device 101. In the case of a receptacle heating element 320, it may be difficult to obtain as close a fit around the article 110 as desired due to the potentially smaller required size of the article with respect to the receptacle 212, particularly with the “door” design of FIG. 13. Furthermore, an article 110 may not be so easily placed onto an axially extending pin-type heating element 420 when inserted into the heating zone 215 laterally. In order to correctly insert an article 110 into such a device, axial translation is always needed, to ensure proper insertion of the susceptor 420 into the article 110.

To address this problem, a heating element 1600 as shown in FIG. 16 may be provided in addition to either or both of the aforementioned heating elements 320, 420. This heating element 1600 takes the form of a tube formed from a material configured to heat in the presence of a varying magnetic field. As can be seen, the heating element 1600 is smaller than the size of the receptacle 212, both in length and in diameter. The heating element 1600 may be configured to fit closely around the outside of an article 110. The heating element 1600 facilitates the insertion of an article 110 therein by comprising a pivot mechanism configured to tilt the heating element 1600 such that its longitudinal axis tilts at an angle to the longitudinal axis 102 of the device 101. The heating element 1600 is configured to tilt towards the opening created by the door 1600. A user may then insert an article 110 into the susceptor 1600, push the heating element 1600 back into the heating zone 215, and close the door 1300. The heating element 1600 may be implemented into any of the split coil device embodiments described in this application.

In any of the embodiments described, the device 101 may be configured to heat the article 110 by producing a varying magnetic field configured to heat a susceptor heating element positioned within the article 110. That is, the article itself may comprise a susceptor heating element. When located in the heating zone, the susceptor heating element positioned within the article generates heat in the presence of the varying magnetic field and thereby heats the article and produces aerosolized material from the aerosol-generating material.

In some of the above described embodiments, the heating arrangement is an inductive heating arrangement. In other embodiments, other types of heating arrangement are used, such as resistive heating. The configuration of the device is generally as described above and so a detailed description will be omitted. In such arrangements the heating assembly 201 comprises a resistive heating generator including components to heat the heating element via a resistive heating process. In this case, an electrical current is directly applied to a resistive heating component, and the resulting flow of current in the heating component causes the heating component to be heated by Joule heating. The resistive heating component comprises resistive material configured to generate heat when a suitable electrical current passes through it, and the heating assembly 201 comprises electrical contacts for supplying electrical current to the resistive material.

In embodiments, the heating element forms the resistive heating component itself. In embodiments the resistive heating component transfers heat to the heating element, for example by conduction.

Although the embodiments described herein so far have described a split coil capable of being opened to provide access to the heating zone 215 of the device 101, it is also envisaged that a device 101 configured to heat an article through only resistive heating may utilize a similar concept, to provide the same technical advantages. For example, the heating arrangement of a device may comprise a tubular resistive heating element, which forms the receptacle 212. In this case, heat can be generated by passing an electric current through the receptacle 212 surrounding an article 110 in use without the use of a conductive coil arrangement. Such a heating element may also be provided to be split, i.e. to comprise one or more circumferential discontinuities. Along with corresponding discontinuities in the housing 103 of the device 101, and with any of the opening mechanisms described in relation to other embodiments such as axially or circumferentially sliding doors, or the hinge arrangements of FIG. 8 or 13, lateral access to the heating zone 215 may be provided. The discontinuities in the circumference of the resistive heating element receptacle in this embodiment may also be provided with connection means 700 to facilitate the connection between the portions of the receptacle 212 when the device is closed. It is also envisaged that the resistive heating receptacle portions may not need to be connected to one another to operate, and that each portion is independently configured to generate heat through resistive heating when a current is passed therethrough. The side access to the heating zone 215 facilitates insertion and minimises risk of damage to the article 110 upon insertion. The device in these embodiments may or may not still be provided with an opening 104 through which the article 110 may be inserted into the device axially.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An aerosol provision device for generating an aerosol from aerosol-generating material, comprising:
a heating assembly comprising:
a heating zone for receiving at least a portion of an article comprising aerosol-generating material;
a magnetic field generator configured to generate a varying magnetic field comprising a coil at least partially encircling the heating zone;
wherein the coil is separable along a juncture.

2. The aerosol provision device of claim 1, wherein the coil defines a longitudinal axis, and the coil is separable in a direction perpendicular to the longitudinal axis.

3. The aerosol provision device of claim 1, wherein the coil defines a longitudinal axis, and the coil is separable in a direction along the longitudinal axis.

4. The aerosol provision device of claim 1, wherein the coil is arranged to be separable into a first coil portion and a second coil portion.

5. The aerosol provision device of claim 4, wherein the first portion is movable relative to the second portion to provide access to the heating zone.

6. The aerosol provision device of claim 4, wherein the first coil portion and the second coil portion are electrically connected in an operating condition.

7. The aerosol provision device of claim 4, comprising a housing, the housing being separable into a first housing portion and a second housing portion.

8. The aerosol provision device of claim 7, wherein the first coil portion is in the first housing portion and the second coil portion is in the second housing portion.

9. The aerosol provision device of claim 7, wherein the first housing portion is movable with respect to the second housing portion by a hinge mechanism.

10. The aerosol provision device of claim 9, wherein the first housing portion is arranged to pivot with respect to the second housing portion about a line parallel to the longitudinal axis of the device.

11. The aerosol provision device of claim 9, wherein the first housing portion is arranged to pivot with respect to the second housing portion about a line perpendicular to the longitudinal axis of the device.

12. The aerosol provision device of claim 7, wherein the first housing portion is movable with respect to the second housing portion by a sliding mechanism.

13. The aerosol provision device of claim 4, wherein the second coil portion is indirectly electrically connected to the first coil by the first coil portion.

14. The aerosol provision device of claim 4, wherein the first coil portion is a separate component to the second coil portion.

15. The aerosol provision device of claim 4, wherein the first coil portion is integral with the second coil portion.

16. The aerosol provision device of claim 1, wherein the heating assembly comprising a heating element.

17. The aerosol provision device of claim 16, wherein the heating element defines the heating zone.

18. The aerosol provision device of claim 16, wherein the heating element is separable into a first heating portion and a second heating portion.

19. An aerosol generating device for generating an aerosol from aerosol-generating material, comprising:
a heating assembly comprising:
a heating element defining a heating zone for receiving at least a portion of an article comprising aerosol-generating material; and
wherein the heating element is separable along a juncture.

20. An aerosol provision device system comprising the aerosol provision device of claim 1, and an article containing aerosol generating material, in which the article is at least partially receivable in the heating zone of the aerosol provision device.
